(19) United States
(12) Patent Application Publication
(10) Pub. No.: US 2019/0006776 A1
(43) Pub. Date: Jan. 3, 2019

(54) BATTERY CELL CAP WITH INTEGRATED FUSIBLE LINK AND METHOD OF ATTACHING TO AN ELECTRICAL INTERCONNECTION

(71) Applicant: NextEV USA, Inc., San Jose, CA (US)

(72) Inventors: Austin L. Newman, San Jose, CA (US); Alexander J. Smith, White Lake, MI (US)

(21) Appl. No.: 15/638,000

(22) Filed: Jun. 29, 2017

(51) Int. Cl. H01R 11/28; H01M 2/04; H01R 4/28; H01R 13/447

(52) U.S. Cl. CPC H01R 11/284; H01M 2/0465; H01M 2/0408; H01R 4/28; H01R 13/447; H01R 11/287

(57) ABSTRACT

Devices, methods, and systems are provided that incorporate and support a number of physical fusible links arranged in a terminal of a battery cell. The fusible links are configured as legs connecting a raised platform of a battery cell cap to a conductive base portion of the battery cell cap. Each of the fusible link legs is sized and shaped to function as a fusible link. The fusible link legs include a controlled cross-sectional area disposed along a length of the material making up the fusible link leg. In an overcurrent situation, the connection between an electrical system and a battery cell having the integrated fusible link legs is severed by the overcurrent melting the legs.

### FIELD

The present disclosure is generally directed to battery cell construction, in particular, toward battery cell caps including integrated fusible links.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

Vehicles employing at least one electric motor and power system store electrical energy in a number of battery cells. These battery cells are typically connected to an electrical control system to provide a desired available voltage, ampere-hour, and/or other electrical characteristics. In some cases, the battery cells may be connected to a busbar associated with the electrical control system. This busbar may be configured to distribute energy stored in the connected battery cells to one or more electric motors of the vehicle. The connection may be made by a physical interconnection or welding.

In some cases, the battery cells may include a number of internal or external protective devices such as pressure, temperature, current (PTC) switches, current interrupt devices (CID), vents, and/or protection circuit boards. Many of these devices are intended to prevent over-temperature, high pressure, current surges, and/or over-charges. However, the systems are prone to failure and tend to be unreliable in certain environmental conditions.

### BRIEF DESCRIPTION OF THE DRAWINGS

FIG. 1A is a plan view of a battery cell with integrated fusible links in accordance with embodiments of the present disclosure;

FIG. 1B is an elevation view of a battery cell with integrated fusible links in accordance with embodiments of the present disclosure;

FIG. 1C is a perspective view of a battery cell with integrated fusible links in accordance with embodiments of the present disclosure;

FIG. 1D is a detail perspective view of an upper portion of the battery cell shown in FIG. 1C;

FIG. 2A is a plan view of a battery cell terminal cap with integrated fusible links in accordance with embodiments of the present disclosure;

FIG. 2B is an elevation view of a battery cell terminal cap with integrated fusible links in accordance with embodiments of the present disclosure;

FIG. 2C is a perspective view of a battery cell terminal cap with integrated fusible links in accordance with embodiments of the present disclosure;

FIG. 2D is a detail perspective view of the battery cell terminal cap with integrated fusible links shown in FIG. 2B;

FIG. 3 is a perspective view of a battery cell terminal cap with two integrated fusible links in accordance with embodiments of the present disclosure;

FIG. 4 is a perspective view of a battery cell terminal cap with four integrated fusible links in accordance with embodiments of the present disclosure;

FIG. 5 is a perspective view of a battery cell terminal cap with six integrated fusible links in accordance with embodiments of the present disclosure;

FIG. 6 is a perspective view of a battery cell with integrated fusible links and attached electrical interconnections in accordance with embodiments of the present disclosure;

FIG. 7A is a plan view of a battery cell with integrated fusible links in a first electrical interconnection attachment state;

FIG. 7B is an elevation view of the battery cell with integrated fusible links in the first electrical interconnection attachment state shown in FIG. 7A;

FIG. 7C is a plan view of a battery cell with integrated fusible links in a second electrical interconnection attachment state;

FIG. 7D is an elevation view of the battery cell with integrated fusible links in the second electrical interconnection attachment state shown in FIG. 7C;

FIG. 7E is a plan view of a battery cell with integrated fusible links in a third electrical interconnection attachment state;

FIG. 7F is an elevation view of the battery cell with integrated fusible links in the third electrical interconnection attachment state shown in FIG. 7A;

FIG. 7G is a plan view of a battery cell with integrated fusible links in a fourth electrical interconnection attachment state;

FIG. 7H is an elevation view of the battery cell with integrated fusible links in the fourth electrical interconnection attachment state shown in FIG. 7G; and

FIG. 8 is a flow diagram of a method for selectively supporting a battery cell cap during a terminal tab weld operation in accordance with embodiments of the present disclosure.

### DETAILED DESCRIPTION

Embodiments of the present disclosure will be described in connection with energy storage devices, and in some embodiments a battery cell of an electric vehicle energy storage system.

Battery cells may be connected to one another and/or attached to a busbar of a battery system via a number of electrical interconnections. These electrical interconnections are generally made between the positive and/or negative terminals of a battery cell and respective positive and/or negative connection points on the busbar. In general, the positive terminal may be disposed on a first end of a battery cell and the negative terminal may be disposed on an opposite second end of the battery cell. In some embodiments, the negative terminal of the battery cell may be found on any conductive portion of the can, or housing, of the battery cell. This housing may be electrically separated and/or isolated from the positive terminal via at least one electrical insulating element (e.g., gasket, non-conductive material, etc.).

Typically, cylindrical battery cells include a button cap, or cover, corresponding to the positive terminal. The button cap is made from a conductive material and can include a formed portion, or protrusion, extending in an axial direction of the cylindrical battery cell away from a center of the battery cell. Among other things, this formed portion of the button cap provides a raised platform for electrical interconnection to an electrical system. In the case of some electrical vehicle battery systems, the raised platform provides a surface to which an electrical interconnection, or tab, may be attached (e.g., welded, affixed, etc.).

Modern battery cells may include a number of safety features to protect against certain types of failures. These failures may include over temperatures, over pressure, and/or current surges. In some cases, a gas release vent may be built into a portion of the battery cell which can relieve pressure inside the battery cell and prevent rupture of the battery cell. The gas is generally released through one or more vent holes disposed in a portion of the battery cell, such as the button cap. Vent holes disposed in a button cap are typically arranged around a periphery of the raised platform and sized such that an amount of gas may be released without compromising the structural integrity of the button cap during welding or other attachment operations.

Many of the safety and/or protection features currently used in modern battery cells fail to reliably operate over a wide range of environmental conditions such as high-temperature, high-humidity and/or wet environments. Moreover, the safety features may not be reliable in certain battery cell arrangements and/or configurations (e.g., series and/or parallel arrangement and attachment of multiple battery cells in a battery system, etc.).

It is with respect to the above issues and other problems that the embodiments presented herein were contemplated. It is an aspect of the present disclosure to provide methods, devices, and systems that incorporate and support a number of physical fusible links disposed in a terminal of a battery cell. For instance, the present disclosure describes a number of legs, acting as fusible links, connecting a raised platform of a button cap to a conductive base portion of the button cap. Each of the legs may be sized and/or shaped to function as a fusible link, for example in an overcurrent situation so, upon experiencing a surge of current over a particular threshold value, the connection from the electrical system to the battery is severed by the current melting the legs. Among other things, the melted legs disconnect the battery cell from the busbar.

In some embodiments, the button cap having the fusible link legs may be supported by an assembly tool during manufacturing and/or attachment to an electrical interconnection (e.g., terminal tab). While most button caps of cylindrical battery cells are sized to resist the force of a clamping fixture during a weld operation, the size and thickness of the button caps is excessive for post manufacturing operations (e.g., installation, implementation, etc.). In some embodiments, the present disclosure describes a welding support blade that may be configured to insert between the fusible link legs and under the raised platform of the button cap acting as a support during the weld operation. This assembly tool and approach allows the busbar to be pressed firmly without adding stress into the button top of the cylindrical battery cell.

In some embodiments, the fusible links may be integrated into the button cap of a positive terminal, into a portion of the housing and/or negative terminal, etc., and/or combinations thereof.

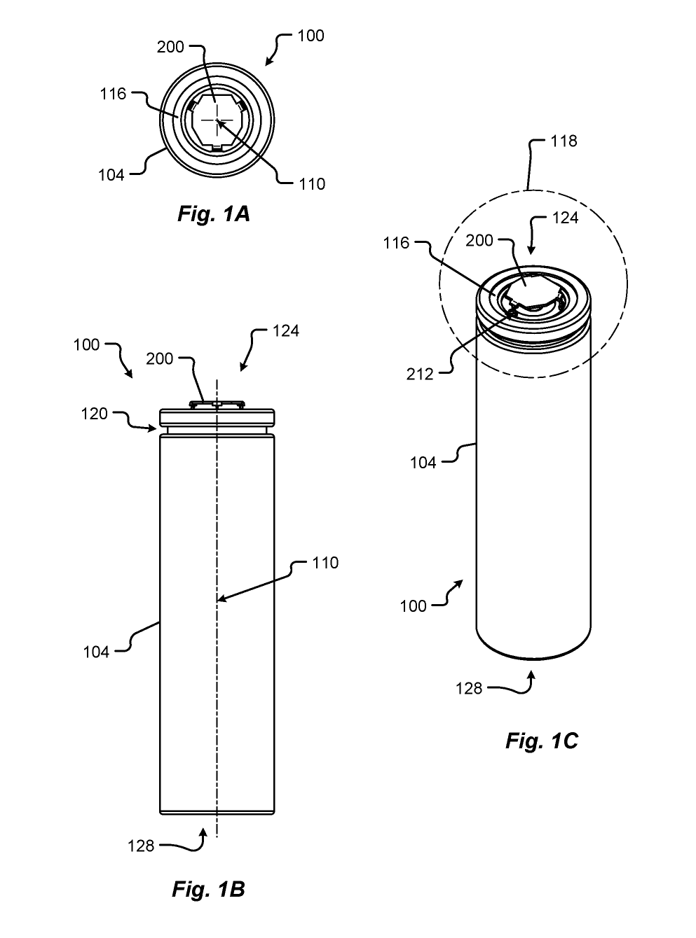

Referring now to FIGS. 1A-1D, various views of a battery cell 100 are shown in accordance with embodiments of the present disclosure. The battery cell 100 may comprise a housing 104, a top portion 124, a bottom portion 128, and one or more terminals. As shown in FIGS. 1A-1D, a first terminal may correspond to a positive terminal disposed at the top portion 124 of the battery cell 100. In some embodiments, the battery cell cap 200 may correspond to the positive terminal of the battery cell 100. In one embodiment, a second terminal may correspond to the negative terminal of the battery cell 100. The second terminal may be disposed opposite the positive terminal (e.g., at the bottom portion 128 of the battery cell 100). In one embodiment, the second terminal may be disposed on a side of the battery cell 100 other than the bottom portion 128. As provided above, the second terminal of the battery cell 100 may be found on any conductive portion of the can, or housing 104, of the battery cell 100. This housing 104 may be electrically separated and/or isolated from the positive terminal via at least one electrical insulating element 116 (e.g., gasket, non-conductive material, etc.).

The first terminal, or battery cell cap 200, may be insulated from the second terminal, or other part of the battery cell 100, via an insulation element 116. The insulation element 116 may be configured to electrically isolate the first terminal from the second terminal, housing 104, or other part of the battery cell 100. In some embodiments, the insulation element 116 may be made from a plastic, cardboard, paper, linen, composite, or other non-conductive material.

In one embodiment, the battery cell 100 may be substantially cylindrical in shape. Additionally or alternatively, the battery cell 100 may be symmetrical about at least one axis. For example, the battery cell 100 may be substantially symmetrical about a center axis 110 running from the top portion 124 to the bottom portion 128 of the battery cell 100. The battery cell 100 may include one or more manufacturing features 120 including, but in no way limited to, indentations, alignment marks, reference datum, location features, tooling marks, orientation features, etc., and/or the like. As shown in FIG. 1B, the manufacturing feature 120 of the battery cell 100 may be a rolled, or sealed, portion of the battery cell 100 (e.g., disposed near a top portion 124 of the battery cell 100).

In any event, the battery cell 100 may be configured to store energy via one more chemicals contained inside the housing 104. In some embodiments, the battery cell 100 may be rechargeable and may include one or more chemical compositions, arrangements, or materials, such as, lithium-ion, lead-acid, aluminum-ion, nickel-cadmium, nickel metal hydride, nickel-iron, nickel-zinc, magnesium-ion, etc., and/or combinations thereof. The positive terminal of the battery cell 100 may correspond to the cathode and the negative terminal may correspond to the anode. When connected to a busbar, current from the battery cell 100 may be configured to flow from the terminals of the battery cell 100 through the busbar to one or more components of an electric power distribution system. This current flow may provide power to one or more electrical elements associated with an electric vehicle.

In some embodiments, the elements comprising the battery cell 100 may be at least partially captured by one or more portions of the housing 104. For example, the housing 104 may be formed in a substantially cylindrical shape including an internal volume configured to receive and/or hold a battery chemistry, cathode/anode layers, a battery cell core, a gas vent, a portion of a battery cell cover, etc. Additionally or alternatively, the housing 104 may include at least one deformed, crimped, rolled, or shaped manufacturing feature 120 providing a space disposed at the top portion 124 of the battery cell 100 for capturing the positive terminal battery cell cap 200. For instance, the manufacturing feature 120 may provide a first support surface preventing axial translation of the battery cell cap 200 in a first direction. A rolled or crimped portion of the housing 104 disposed at the top portion 124 of the battery cell 100 may provide a second support surface preventing axial translation of the battery cell cap 200, and/or other elements inside the housing 104, in a second direction opposite the first direction.

FIG. 1D shows a detail perspective view of the top portion 124 of the battery cell 100 in accordance with embodiments of the present disclosure. As shown in FIG. 1D, the battery cell cap 200 is shown including a number of fusible link legs 212 elevating or offsetting an electrical contact area of the battery cell cap 200 above an upper surface 108 of the housing 104 of the battery cell 100. In some embodiments, the vent spaces 214 between the fusible link legs 212 may be configured to provide a gas vent path from a space inside the battery cell 100 and/or housing 104 to an environment outside of the battery cell 100 and/or housing 104.

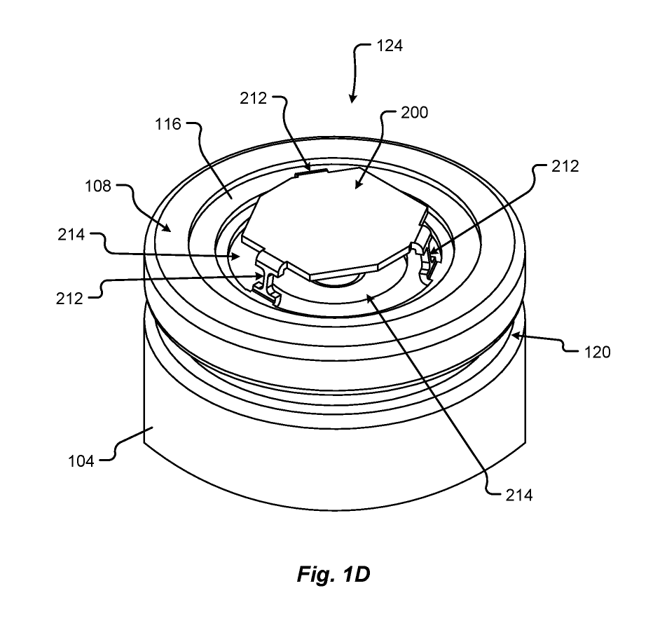

FIGS. 2A-2D show various views of a battery cell cap 200 in accordance with embodiments of the present disclosure. While the battery cell cap 200 may include any number of fusible link legs 212 having fusible link features, it should be appreciated that the features, arrangement, and description associated with the battery cell cap 200 illustrated FIGS. 2A-2D may apply to any battery cell cap 200, 300, 400, 500 recited herein.

In some embodiments, the battery cell cap 200 may include a base ring 204 that is offset some distance from an electrical contact disk 208. The electrical contact disk 208 may be arranged substantially parallel to the base ring 204. In any event, the electrical contact disk 208 may be physically connected to the base ring 204 via one or more fusible link legs 212. In one embodiment, the electrical contact disk 208 and the base ring 204 may be formed from a single piece of material. For instance, a single piece of material (e.g., sheet metal strip, etc.) may be inserted into a manufacturing tool including, but in no way limited to, a punch, press, die, cutting tool, etc., and/or combinations thereof. The manufacturing tool may form the offset between the electrical contact disk 208 and the base ring 204, cut the vent spaces 214, shape the fusible link legs 212, and/or separate the formed battery cell cap 200 from the single piece of material. In some cases, these operations may be performed simultaneously and/or substantially simultaneously. The formed fusible link legs 212 may be disposed at an angle to the surfaces of the electrical contact disk 208 and/or the base ring 204. This angle may correspond to a draft angle of the manufacturing tool or a portion thereof.

FIG. 2D shows a detail elevation view of a fusible link leg 212 taken from an area 202 of the battery cell cap 200 shown in FIG. 2B. In particular, an electrical contact surface of the electrical contact disk 208 is shown offset from an upper surface of the base ring 204 by a first height H1. In some embodiments, the first height H1 may be sized to provide a sufficient vent space 214 height, a protruding electrical contact surface extending in an axial direction away from an upper surface 108 of the housing 104 of the battery cell 100, and/or a sufficient arc prevention gap between the electrical contact disk 208 and the base ring 204.

The fusible link leg 212 may include a controlled cross-sectional area 216 disposed along a length of the material making up the fusible link leg 212. The controlled cross-sectional area 216 may define the overcurrent melt area of the fusible link leg 212. For instance, in the event an installed battery cell with integrated fusible link 100 experiences a surge of current over a particular threshold value, the connection from the electrical system to the battery cell 100 may be severed by the current melting the legs at the controlled cross-sectional area 216. This melting may physically separate and electrically disconnect the battery cell 100 from a busbar or other component of an electrical system. In some embodiments, the controlled cross-sectional area 216 may correspond to a reduced cross-sectional area of the fusible link leg 212. For example, the fusible link leg 212 may step down, or decrease, from a first cross-sectional area to a second cross-sectional area that is less than the first cross-sectional area.

In some embodiments, the fusible link leg 212 may be sized having an arc gap height H2, a width W1, and a depth extending from a portion of the base ring 204 to a portion of the electrical contact disk 208, or vice versa. The width W1 and depth may make up the cross-sectional area of the fusible link leg 212, and the arc gap height H2 may define a length of material for the fusible link leg 212 that is configured to melt in an overcurrent scenario. When melted, the arc gap height H2 provides a physical and electrical separation between the battery cell 100 and a busbar and/or other component of an electrical system. The distance of the arc gap height H2 may be configured to prevent arcing between a portion of the battery cell 100 and the busbar and/or other component of an electrical system. In some embodiments, the dimension of the arc gap height H2 may be determined based on a defined dielectric withstand voltage, temperature, pressure, a composition of the environment (e.g., gas, air, nitrogen, etc.) surrounding the battery cell 100, Paschen's law, and/or combinations thereof.

In an overcurrent scenario, it is an aspect of the present disclosure that each of the fusible link legs 212 melts completely separating the electrical contact disk 208 from the base ring 204 of the battery cell 100.

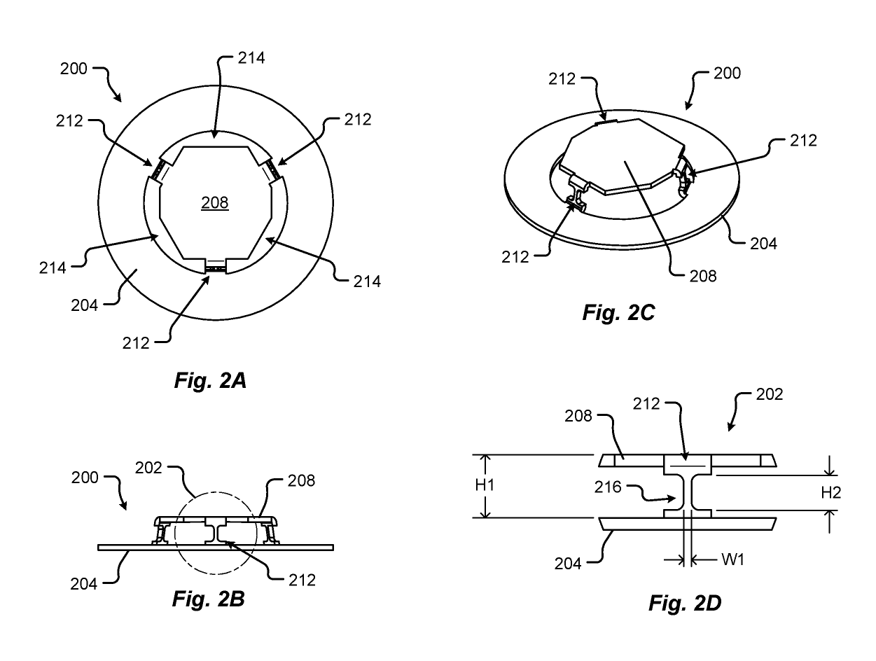

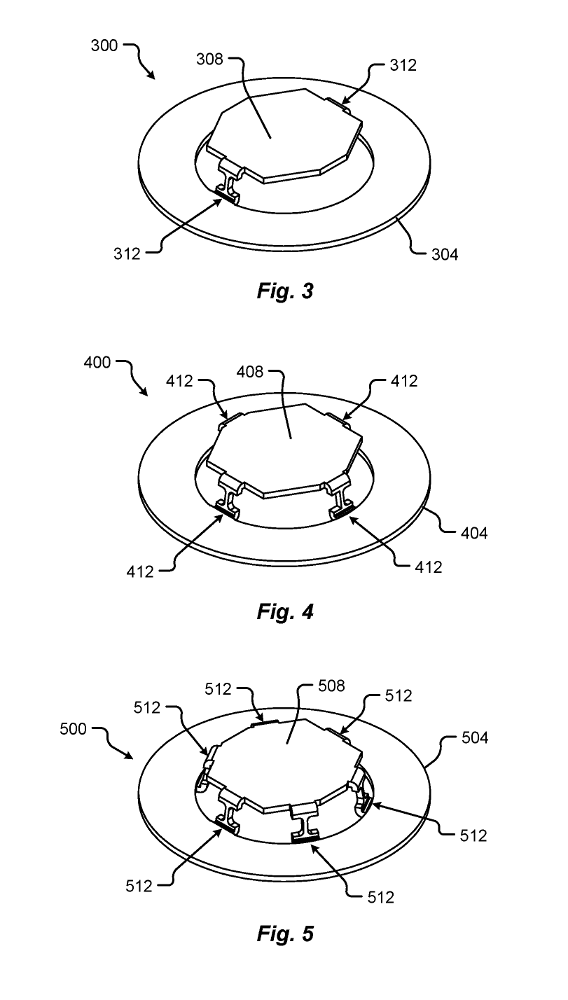

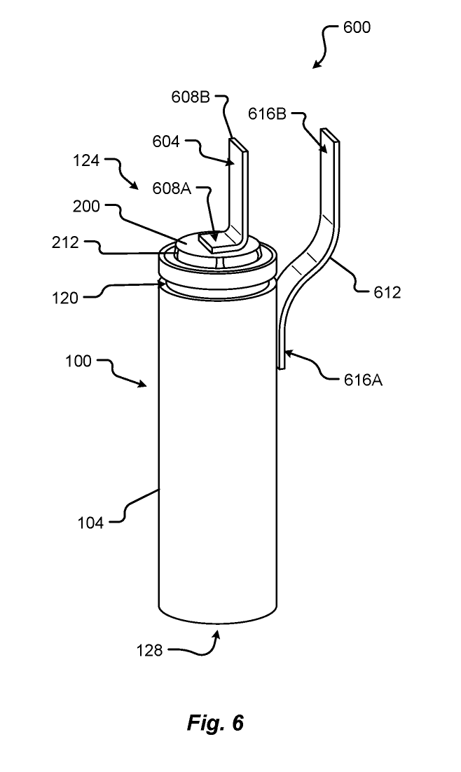

FIGS. 3-5 show perspective views of a battery cell cap 300, 400, 500 having two, four, and six fusible link legs 312, 412, 512, respectively. While the battery cell cap 200 described in conjunction with FIGS. 1A-2D show three fusible link legs 212 disposed around a periphery of the electrical contact disk 208, it should be appreciated that the present disclosure is not so limited and may include any number of fusible link legs 212, 312, 412, 512. As shown in FIGS. 3-5, each battery cell cap 300, 400, 500 includes a base ring 304, 404, 504, an electrical contact disk 308, 408, 508, and a number of fusible link legs 312, 412, 512. The structure and arrangement of the battery cell caps 300, 400, 500 may be similar, if not identical, to the structure and arrangement of the battery cell cap 200 described in conjunction with FIGS. 1A-2D.

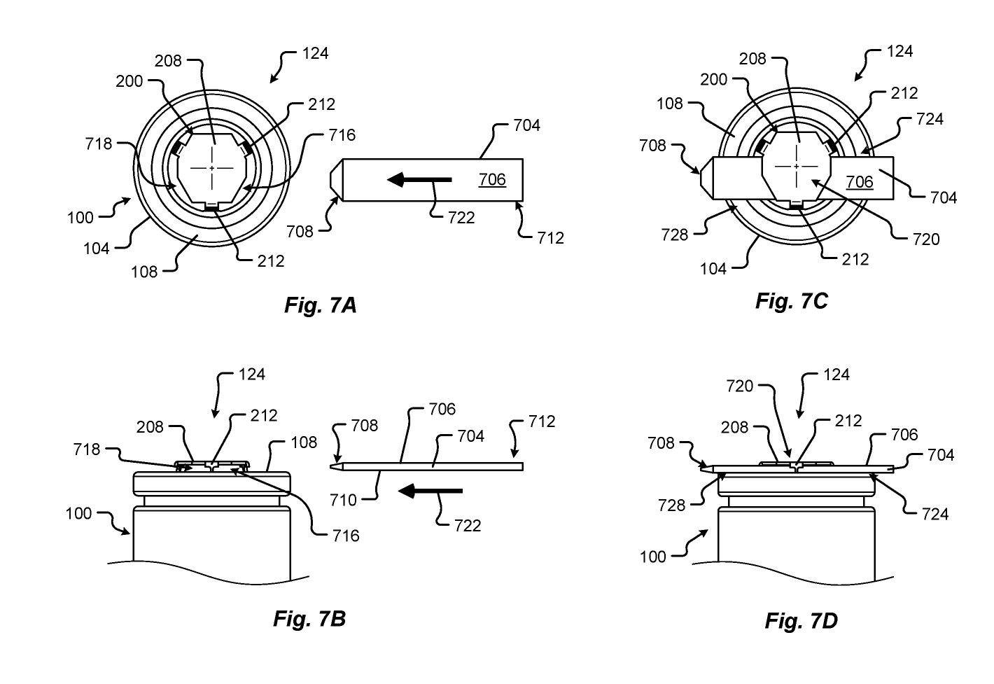

FIG. 6 shows a perspective view of a connection-ready battery cell 600 including a first terminal tab 604 and a second terminal tab 612 connected to the first terminal battery cell cap 200 and second terminal of the battery cell 100, respectively. The first terminal tab 604 is shown attached to the battery cell cap 200 at a first attachment point 608A. The second terminal tab 612 is shown attached to a second terminal of the battery cell 100 at a second attachment point 616A. In some embodiments, the attachment may include welding, brazing, or soldering the first terminal tab 604 to a portion of the battery cell cap 200 (e.g., the electrical contact disk 208, etc.) and welding, brazing, or soldering the second terminal tab 612 to the second terminal of the battery cell 100. Although shown as connected at the top 124 and side of the housing 104 of the battery cell 100, respectively, the first and second terminal tabs 604, 612 may be connected to different ends, portions, or areas, or parts of the battery cell 100 that are electrically separated by at least one insulation element 116.

In some embodiments, the first terminal tab 604 and the second terminal tab 612 may be configured as flat solid metal connectors. The flat solid metal connectors may be made from a conductive material or coating including, but in no way limited to, copper, aluminum, gold, silver, platinum, iron, zinc, nickel, etc., and/or combinations thereof. In any event, these flat solid metal connectors may be bent and/or configured to extend from at least one surface of the connection-ready battery cell 600. As shown in FIG. 6, the first and second terminal tabs 604, 612 are bent to extend in the same axial direction, and/or parallel to the center axis 110, of the connection-ready battery cell 600. Additionally or alternatively, a flat planar portion of the first terminal tab 604 is disposed substantially parallel to, and offset from, a flat planar portion of the second terminal tab 612. In some embodiments, the offset distance from the first terminal tab 604 to the second terminal tab 612 may correspond to an offset distance between terminal tabs of a mating busbar.

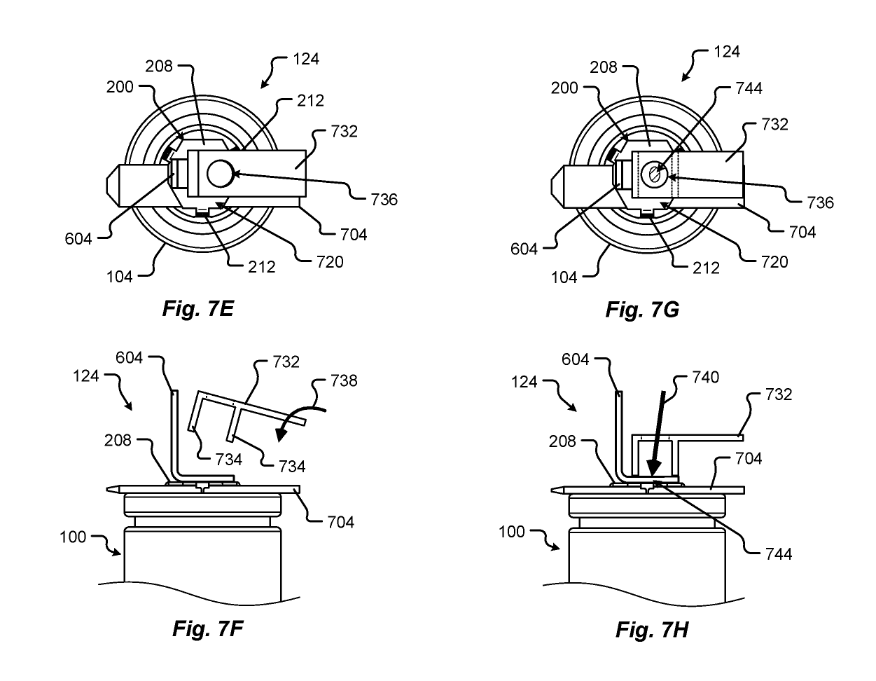

FIGS. 7A-7H show various views of a battery cell 100 with integrated fusible links in electrical interconnection attachment states. The electrical interconnection attachment states illustrated in FIGS. 7A-7H may correspond to one or more assembly states associated with attaching a terminal tab to a receiving terminal of a battery cell 100. For instance, the electrical interconnection attachment may include welding a first terminal tab 604 to the battery cell cap 200 of a battery cell 100 while being supported by a portion of an assembly tool.

Referring to FIGS. 7A and 7B, a plan view and an elevation view respectively of a battery cell 100 in a first electrical interconnection attachment state are shown in accordance with embodiments of the present disclosure. In FIGS. 7A and 7B, the battery cell 100 is positioned relative to an assembly tool weld support blade 704. This relative positioning may include moving one or more of the battery cell 100, the weld support blade 704, and/or combinations thereof. In particular, the weld support blade 704 is aligned to insert between fusible link legs 212 (e.g., as shown in the plan view of FIG. 7A) in a first open space 716 under the electrical contact disk 208 (e.g., as shown in the elevation view of FIG. 7B). In particular, the upper surface 706 of the weld support blade 704 may be aligned to index into the first open space 716 and configured to support an underside of the electrical contact disk 208 during a terminal tab weld operation. Additionally or alternatively, the lower surface 710 of the weld support blade 704 may be aligned to rest on, or otherwise contact, an upper surface 108 of the battery cell 100 during a terminal tab weld operation. In one embodiment, the weld support blade 704 may include a length dimension greater than 18.0 millimeters (0.71 inches), a width dimension between 1.0 millimeter (0.04 inches) and 9.0 millimeters (0.35 inches), and/or a height dimension between 1.0 millimeter (0.04 inches) and 9.0 millimeters (0.35 inches).

The weld support blade 704 may include a tapered leading edge 708, or tip. The tapered leading edge 708 may be configured to self-center and/or self-align as the weld support blade 704 is inserted into the first open space 716 under the battery cell cap 200 and between two or more fusible link legs 212. In some embodiments, the tapered leading edge 708 may include one or more angled, chamfered, and/or lead-in features disposed at an end of the weld support blade 704. The tapered leading edge 708 may contact a portion of the battery cell cap 200 and align, or self-center, the weld support blade 704 in a vertical and/or horizontal direction relative to a planar surface of the electrical contact disk 208. Once the weld support blade 704 and the battery cell 100 are aligned relative to one another, the weld support blade 704 may be indexed in a direction 722 toward the battery cell 100. In some embodiments, an actuator may be connected to the weld support blade 704 at an end 712 opposite the tapered leading edge 708 and configured to move the weld support blade 704 in a direction 722 toward the battery cell 100. In some embodiments, the weld support blade 704 may be made from a nonconductive material and/or include one or more electrically insulated surfaces. For example, the weld support blade 704 may include an upper surface 706 that is connected to the lower surface 710 via a nonconductive, or insulating, element. In this example, there is no electrically conductive path from the upper surface 706 to the lower surface 710. As another example, the weld support blade 704 may be made from a metal that includes one or more surfaces 706, 710 that are electrically insulated from one another. In some embodiments, the weld support blade 704 may be thermally insulated and/or configured to prevent heat (e.g., generated as a result of a weld operation, etc.) from transferring to other elements or portions of the battery cell 100.

FIGS. 7C and 7D show a plan view and an elevation view, respectively, of the battery cell 100 in a second electrical interconnection attachment state in accordance with embodiments of the present disclosure. As shown in FIGS. 7C and 7D, the weld support blade 704 is inserted through the first open space 716 and extended out of a second open space 718 of the battery cell cap 200 such that the weld support blade 704 is disposed in a support position underneath the electrical contact disk 208. The support position of the weld support blade 704 may provide a support or resistance to force applied at a terminal tab weld area 720. In some embodiments, the support position may correspond to the upper surface 706 of the weld support blade 704 contacting an underside of the electrical contact disk 208. In one embodiment, the support position may correspond to the upper surface 706 of the weld support blade 704 being offset from an underside of the electrical contact disk 208 such that a force applied to the upper side of the electrical contact disk 208 displaces a portion of the battery cell cap 200 moving an underside of the electrical contact disk 208 into contact with the upper surface 706 of the weld support blade. In some embodiments, the weld support blade 704 may span a portion of the battery cell 100 such that the lower surface 710 of the weld support blade 704 contacts opposite sides 724, 728 of an upper surface 108 of the battery cell 100. This spanned disposition of the weld support blade 704 provides at least two points of contact between the weld support blade 704 and the battery cell housing 104 (e.g., the upper surface 108 of the housing 104) allowing for greater resistance to blade displacement when subjected to an assembly or interconnection force applied at the terminal tab weld area 720 (e.g., between the two points of contact).

FIGS. 7E and 7F show a plan view and an elevation view, respectively, of the battery cell 100 in a third electrical interconnection attachment state in accordance with embodiments of the present disclosure. In FIGS. 7E and 7F a first terminal tab 604 is placed onto the electrical contact disk 208 prior to being held in place (e.g., clamped, etc.) during a weld operation. For example, a terminal clamp 732 is shown in a retracted, or unclamped, state apart from the first terminal tab 604. In particular, the terminal clamp 732 including clamping contact elements 734 is shown separated from the first terminal tab 604. The terminal clamp 732 may be configured to be rotated (e.g., via a rotary actuator, etc.) and/or moved in a direction 738 toward the first terminal tab 604. In some embodiments, the terminal clamp 732 may be actuated into an actuated, or clamped state, where clamping contact elements 734 contact the first terminal tab 604 forcing a portion of the first terminal tab 604 into direct contact with a portion of the electrical contact disk 208. Although shown as protruding elements, it should be appreciated that the clamping contact elements 734 may include one or more contact surfaces substantially planar with the lower surface 710 of the weld support blade 704.

The terminal clamp 732 may include an aperture 736, through hole, or clearance area disposed between the clamping contact elements 734, or some other pressure/contact surfaces, of the terminal clamp 732. Among other things, the aperture 736 may provide an area through which a laser welder, welding head, or other affixing tool may operate to fuse, bond, weld, braze, or otherwise affix the first terminal tab 604 to the battery cell cap 200.

FIGS. 7G and 7H show a plan view and an elevation view, respectively, of the battery cell 100 in a fourth electrical interconnection attachment state in accordance with embodiments of the present disclosure. As shown in FIGS. 7G and 7H, the terminal clamp 732 is in a clamped state applying contact pressure to the first terminal tab 604, forcing the first terminal tab 604 against the battery cell cap 200. In some embodiments, this contact pressure may force a portion of the first terminal tab 604 against the electrical contact disk 208 in a weld area 744. It is an aspect of the present disclosure that a welder may direct heat in a direction 740 toward the weld area 744. Examples of the welder may include, but are in no way limited to, a laser welder, TIG welder, MIG welder, arc welder, spot welder, gas welder, brazing tool, soldering tool, and/or some other heating element. In some embodiments, the welder may heat a portion of the first terminal tab 604 disposed above the weld area 744. In this case, when the first terminal tab 604, the electrical contact disk 208, and/or some interstitial element (e.g., filler material, solder, etc.) heats to a melting point, material from the first terminal tab 604 may mix with material from the contact disk 208, and/or some interstitial element. Once the mixed molten material cools, the first terminal tab 604 is welded, joined, or fused to the electrical contact disk 208. In some embodiments, the terminal clamp 732 may remain in the clamped state until the mixed molten material cools and/or solidifies.

Once joined, the terminal clamp 732 may move to a retracted position (e.g., as shown in FIGS. 7E and 7F) and the weld support blade 704 may be retracted from the support position into a retracted position (e.g., as shown in FIGS. 7A and 7B). When the one or more terminal tabs 604, 612 are welded to the battery cell 100, the battery cell may be arranged as the connection-ready battery cell 600 illustrated and described in conjunction with the schematic perspective view of FIG. 6.

The movement, indexing, alignment, positioning, and/or orientation of one or more components of the welding support system described above may be performed by at least one actuation system. The actuation system may include one or more grippers, actuators, robots, slides, rails, clamps, position-feedback devices, sensors, mechanisms, machines, and/or the like, etc. The actuation system may be configured to move one or more components of the system including, but in no way limited to, the battery cell 100, the first terminal tab 604, the weld support blade 704, the terminal clamp 732, etc., and/or combinations thereof. In some embodiments, the actuation system and/or other components of the weld support system may receive instructions and/or commands from a controller (e.g., a specially programmed processor and memory configured to actuate and/or move the components of the weld support system.

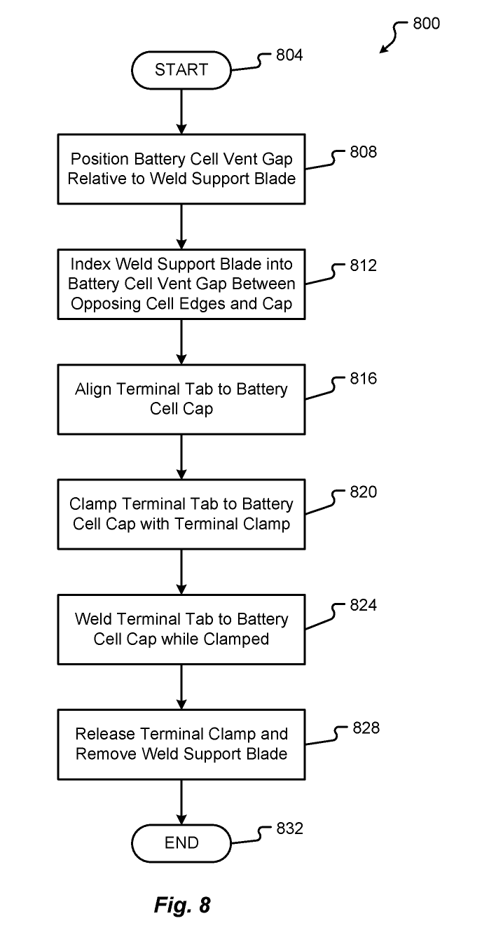

FIG. 8 is a flow diagram of a method 800 for selectively supporting a battery cell cap 200 during a terminal tab weld operation in accordance with embodiments of the present disclosure. While a general order for the steps of the method 800 is shown in FIG. 8, the method 800 can include more or fewer steps or can arrange the order of the steps differently than those shown in FIG. 8. Generally, the method 800 starts with a start operation 804 and ends with an end operation 832. The method 800 can be executed as a set of computer-executable instructions executed by a controller, and/or computer system, and encoded or stored on a computer readable medium or memory. Hereinafter, the method 800 shall be explained with reference to the systems, components, assemblies, devices, environments, etc. described in conjunction with FIGS. 1-7H.

The method 800 begins at step 804 and proceeds by positioning the battery cell vent gap, or vent space 214, relative to the weld support blade 704 (step 808). As provided above, this relative positioning may include moving one or more of the battery cell 100, the weld support blade 704, and/or combinations thereof. In some embodiments, the positioning may be achieved by a fixture, tool, and/or compliant arm moved by one or more computer controlled actuators.

Next, the method 800 continues by indexing the weld support blade 704 into the vent space 214 between the fusible link legs 212 of the battery cell cap 200 (step 812). In one embodiment, the weld support blade 704 may be indexed from through the vent space 214 from one side of the battery cell 100 under the electrical contact disk 208 to the opposite side of the battery cell 100. Among other things, the span of the weld support blade 704 across opposite sides of the battery cell 100 can provide increased resistance to a clamping force during the weld operation. This increased resistance may be provided by the blade 704 being supported at two ends, while any clamping/welding force is applied to a point, or area, lying between the two supported ends.

The method 800 may proceed by aligning a terminal tab to the battery cell cap 200 (step 816). In one embodiment, the terminal tab may correspond to the first terminal tab 604 as described above. In any event, the alignment of the terminal tab may include aligning a portion of the terminal tab to a portion of the electrical contact disk 208 disposed over the weld support blade 704.

Once the terminal tab is aligned, the method 800 may continue by clamping the terminal tab to the electrical contact disk 208 (step 820). In some embodiments, the terminal tab may be clamped by the terminal clamp 732 described above. The terminal clamp 732 may force a portion of the terminal tab into direct contact with the electrical contact disk 208. In one embodiment, the direct contact allows heat emitted by a welder to pass through the terminal tab to the electrical contact disk 208 welding the components together (step 824).

After the terminal tab is welded, or joined, to the battery cell cap 200, the method 800 continues by releasing the terminal clamp 732 and removing the weld support blade 704 (step 828). The method 800 ends at step 832.

Any of the steps, functions, and operations discussed herein can be performed continuously and automatically.

The exemplary systems and methods of this disclosure have been described in relation to battery cells and terminal welding systems. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a battery cell, comprising: a housing having a first end and a second end and an internal volume disposed between the first and second ends; and a battery cell cap, comprising: a base ring; an electrical contact disk offset a distance from the base ring; and at least one fusible link leg physically and conductively connecting the base ring to the electrical contact disk, wherein the at least one fusible link leg includes a controlled cross-sectional area configured to melt at a predetermined electrical current and break the connection between the base ring and the electrical contact disk along a length of the at least one fusible link leg.

Aspects of the above battery cell further comprise at least one electrochemical storage system disposed within the internal volume of the housing having a positive and a negative connection, wherein the positive connection is electrically interconnected to the battery cell cap and the negative connection is electrically interconnected to the housing. Aspects of the above battery cell include wherein the at least one fusible link leg comprises two or more fusible link legs disposed around a periphery of the electrical contact disk and spaced apart from one another. Aspects of the above battery cell further comprise a vent space disposed between the two or more fusible link legs and under the electrical contact disk including a passage passing from a first side of the electrical contact disk to an opposite side of the electrical contact disk, the vent space providing a fluid vent path from the internal volume of the battery cell to an environment outside of the housing, wherein the passage is sized to receive a length of a weld support blade. Aspects of the above battery cell further comprise a conductive terminal tab welded to a portion of the electrical contact disk and disposed outside of the internal volume of the housing. Aspects of the above battery cell include wherein the base ring, the electrical contact disk, and the two or more fusible link legs are formed from a single piece of metal, and wherein the vent space corresponds to an area of removed material from the single piece of metal. Aspects of the above battery cell include wherein the length of the at least one fusible link leg includes a dimension determined to prevent arcing when the at least one fusible link leg melts and the base ring is physically separated from the electrical contact disk. Aspects of the above battery cell include wherein the dimension determined to prevent arcing is based on a voltage of the electrochemical storage system and a gas surrounding the battery cell cap.

Embodiments include a battery cell cap, comprising: a base ring; an electrical contact disk offset a distance from the base ring; and at least one fusible link leg physically and conductively connecting the base ring to the electrical contact disk, wherein the at least one fusible link leg includes a controlled cross-sectional area configured to melt at a predetermined electrical current and break the connection between the base ring and the electrical contact disk along a length of the at least one fusible link leg.

Aspects of the above battery cell cap include wherein the at least one fusible link leg comprises two or more fusible link legs disposed around a periphery of the electrical contact disk and spaced apart from one another. Aspects of the above battery cell cap further comprise a vent space disposed between the two or more fusible link legs and under the electrical contact disk including a passage passing from a first side of the electrical contact disk to an opposite side of the electrical contact disk, the vent space providing a fluid vent path from the internal volume of a battery cell to an environment outside of the battery cell, wherein the passage is sized to receive a length of a weld support blade. Aspects of the above battery cell cap include wherein the base ring, the electrical contact disk, and the two or more fusible link legs are formed from a single piece of metal, and wherein the vent space corresponds to an area of removed material from the single piece of metal. Aspects of the above battery cell cap include wherein the length of the at least one fusible link leg includes a dimension determined to prevent arcing when the at least one fusible link leg melts and the base ring is physically separated from the electrical contact disk. Aspects of the above battery cell cap include wherein the dimension determined to prevent arcing is based on a voltage of the electrochemical storage system and a gas surrounding the battery cell cap.

Embodiments include a battery cell, comprising: a housing having a first end and a second end and an internal volume disposed between the first and second ends; a battery cell cap, comprising: a base ring; an electrical contact disk offset a distance from the base ring; and at least one fusible link leg physically and conductively connecting the base ring to the electrical contact disk, wherein the at least one fusible link leg includes a controlled cross-sectional area configured to melt at a predetermined electrical current and break the connection between the base ring and the electrical contact disk along a length of the at least one fusible link leg; at least one electrochemical storage system disposed within the internal volume of the housing having a positive and a negative connection, wherein the positive connection is electrically interconnected to the battery cell cap and the negative connection is electrically interconnected to the housing; a first conductive terminal tab having a first end welded to a portion of the electrical contact disk and a second end disposed outside of the internal volume of the housing; and a second conductive terminal tab having a first end welded to a portion of the housing and a second end opposite the first end, wherein a polarity of the first conductive terminal tab is opposite a polarity of the second conductive terminal tab.

Aspects of the above battery cell include wherein the second end of the first conductive terminal tab and the second end of the second conductive terminal tab are configured to affix to a positive and a negative terminal of a battery busbar, respectively. Aspects of the above battery cell include wherein the at least one fusible link leg comprises two or more fusible link legs disposed around a periphery of the electrical contact disk and spaced apart from one another. Aspects of the above battery cell further comprise a vent space disposed between the two or more fusible link legs and under the electrical contact disk including a passage passing from a first side of the electrical contact disk to an opposite side of the electrical contact disk, the vent space providing a fluid vent path from the internal volume of the battery cell to an environment outside of the housing, wherein the passage is sized to receive a length of a weld support blade. Aspects of the above battery cell include wherein the base ring, the electrical contact disk, and the two or more fusible link legs are formed from a single piece of metal, and wherein the vent space corresponds to an area of removed material from the single piece of metal. Aspects of the above battery cell include wherein the length of the at least one fusible link leg includes a dimension determined to prevent arcing when the at least one fusible link leg melts and the base ring is physically separated from the electrical contact disk, and wherein the dimension determined to prevent arcing is based on a voltage of the electrochemical storage system and a gas surrounding the battery cell cap.

Embodiments include a method of attaching a terminal tab to a battery cell, comprising: aligning a weld support blade relative to a battery cell cap of the battery cell, wherein the battery cell cap includes a base ring, an electrical contact disk offset a distance from the base ring, and two or more fusible link legs physically and conductively connecting the base ring to the electrical contact disk, wherein each of the two or more fusible link legs includes a controlled cross-sectional area configured to melt at a predetermined electrical current and break the connection between the base ring and the electrical contact disk along a length of each of the two or more fusible link legs; indexing, via an actuator, the aligned weld support blade into an open space between two of the two or more fusible link legs and under the electrical contact disk, wherein the weld support blade contacts an underside of the electrical contact disk; aligning the terminal tab into contact with a surface of the electrical contact disk; clamping, via a terminal clamp, the terminal tab to the surface of the electrical contact disk over a portion of the electrical contact disk supported by the weld support blade; and welding the terminal tab to the electrical contact disk while the electrical contact disk is supported by the weld support blade.

Aspects of the above method further comprise releasing the terminal clamp from contact with the terminal tab and welded battery cell; and removing, via the actuator, the weld support blade from the open space between the two of the two or more fusible link legs. Aspects of the above method include wherein clamping the terminal clamp includes rotating the terminal clamp from an unclamped state to a clamped state, and wherein releasing the terminal clamp includes rotating the terminal clamp from the clamped state to the unclamped state via a rotary actuator. Aspects of the above method include wherein the weld support blade includes a tapered tip that contacts a portion of the battery cell cap as the weld support blade is indexed into the open space and aligns the weld support blade in at least one of a vertical or horizontal direction relative to a surface of the electrical contact disk. Aspects of the above method include wherein the battery cell includes an upper surface of a cylindrical housing substantially planar to and offset from the underside of the electrical contact disk, and wherein indexing the aligned weld support blade into the open space further comprises: positioning the weld support blade across a diameter of the cylindrical housing of the battery cell. Aspects of the above method include wherein a surface of the weld support blade contacts the upper surface of the cylindrical housing, and wherein the weld support blade is supported at two ends of the weld support blade by the upper surface of the cylindrical housing.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A battery cell, comprising:
a housing having a first end and a second end and an internal volume disposed between the first and second ends; and
a battery cell cap, comprising:
a base ring;
an electrical contact disk offset a distance from the base ring; and
at least one fusible link leg physically and conductively connecting the base ring to the electrical contact disk, wherein the at least one fusible link leg includes a controlled cross-sectional area configured to melt at a predetermined electrical current and break the connection between the base ring and the electrical contact disk along a length of the at least one fusible link leg.

2. The battery cell of claim 1, further comprising:
at least one electrochemical storage system disposed within the internal volume of the housing having a positive and a negative connection, wherein the positive connection is electrically interconnected to the battery cell cap and the negative connection is electrically interconnected to the housing.

3. The battery cell of claim 2, wherein the at least one fusible link leg comprises two or more fusible link legs disposed around a periphery of the electrical contact disk and spaced apart from one another.

4. The battery cell of claim 3, further comprising:
a vent space disposed between the two or more fusible link legs and under the electrical contact disk including a passage passing from a first side of the electrical contact disk to an opposite side of the electrical contact disk, the vent space providing a fluid vent path from the internal volume of the battery cell to an environment outside of the housing, wherein the passage is sized to receive a width, length, and height of a weld support blade.

5. The battery cell of claim 4, further comprising:
a conductive terminal tab welded to a portion of the electrical contact disk and disposed outside of the internal volume of the housing.

6. The battery cell of claim 4, wherein the base ring, the electrical contact disk, and the two or more fusible link legs are formed from a single piece of metal, and wherein the vent space corresponds to an area of removed material from the single piece of metal.

7. The battery cell of claim 4, wherein the length of the at least one fusible link leg includes a dimension determined to prevent arcing when the at least one fusible link leg melts and the base ring is physically separated from the electrical contact disk.

8. The battery cell of claim 7, wherein the dimension determined to prevent arcing is based on a voltage of the electrochemical storage system and a gas surrounding the battery cell cap.

9. A battery cell cap, comprising:
a base ring;
an electrical contact disk offset a distance from the base ring; and
at least one fusible link leg physically and conductively connecting the base ring to the electrical contact disk, wherein the at least one fusible link leg includes a controlled cross-sectional area configured to melt at a predetermined electrical current and break the connection between the base ring and the electrical contact disk along a length of the at least one fusible link leg.

10. The battery cell cap of claim 9, wherein the at least one fusible link leg comprises two or more fusible link legs disposed around a periphery of the electrical contact disk and spaced apart from one another.

11. The battery cell cap of claim 10, further comprising:
a vent space disposed between the two or more fusible link legs and under the electrical contact disk including a passage passing from a first side of the electrical contact disk to an opposite side of the electrical contact disk, the vent space providing a fluid vent path from the internal volume of a battery cell to an environment outside of the battery cell, wherein the passage is sized to receive a length of a weld support blade.

12. The battery cell cap of claim 11, wherein the base ring, the electrical contact disk, and the two or more fusible link legs are formed from a single piece of metal, and wherein the vent space corresponds to an area of removed material from the single piece of metal.

13. The battery cell cap of claim 11, wherein the length of the at least one fusible link leg includes a dimension determined to prevent arcing when the at least one fusible link leg melts and the base ring is physically separated from the electrical contact disk.

14. The battery cell cap of claim 13, wherein the dimension determined to prevent arcing is based on a voltage of an electrochemical storage system of the battery cell and a gas surrounding the battery cell cap.

15. A method of attaching a terminal tab to a battery cell, comprising:
aligning a weld support blade relative to a battery cell cap of the battery cell, wherein the battery cell cap includes a base ring, an electrical contact disk offset a distance from the base ring, and two or more fusible link legs physically and conductively connecting the base ring to the electrical contact disk, wherein each of the two or more fusible link legs includes a controlled cross-sectional area configured to melt at a predetermined electrical current and break the connection between the base ring and the electrical contact disk along a length of each of the two or more fusible link legs;
indexing, via an actuator, the aligned weld support blade into an open space between two of the two or more fusible link legs and under the electrical contact disk, wherein the weld support blade contacts an underside of the electrical contact disk;
aligning the terminal tab into contact with a surface of the electrical contact disk;
clamping, via a terminal clamp, the terminal tab to the surface of the electrical contact disk over a portion of the electrical contact disk supported by the weld support blade; and
welding the terminal tab to the electrical contact disk while the electrical contact disk is supported by the weld support blade.

16. The method of claim 15, further comprising:
releasing the terminal clamp from contact with the terminal tab and welded battery cell; and
removing, via the actuator, the weld support blade from the open space between the two of the two or more fusible link legs.

17. The method of claim 16, wherein clamping the terminal clamp includes rotating the terminal clamp from an unclamped state to a clamped state, and wherein releasing the terminal clamp includes rotating the terminal clamp from the clamped state to the unclamped state via a rotary actuator.

18. The method of claim 16, wherein the weld support blade includes a tapered tip that contacts a portion of the battery cell cap as the weld support blade is indexed into the open space and aligns the weld support blade in at least one of a vertical or horizontal direction relative to a surface of the electrical contact disk.

19. The method of claim 15, wherein the battery cell includes an upper surface of a cylindrical housing substantially planar to and offset from the underside of the electrical contact disk, and wherein indexing the aligned weld support blade into the open space further comprises:
positioning the weld support blade across a diameter of the cylindrical housing of the battery cell.

20. The method of claim 19, wherein a surface of the weld support blade contacts the upper surface of the cylindrical housing, and wherein the weld support blade is supported at two ends of the weld support blade by the upper surface of the cylindrical housing.
